(19) United States
(12) Patent Application Publication
(10) Pub. No.: US 2025/0174420 A1
(43) Pub. Date: May 29, 2025

(54) SHRINK CAP, DEVICE COMPRISING A SHRINK CAP, AND METHOD OF MANUFACTURING A SHRINK CAP

(71) Applicant: Marcel P. Hofsaess, Steintahleben (DE)

(72) Inventor: Marcel P. Hofsaess, Steintahleben (DE)

(21) Appl. No.: 18/771,175

(22) Filed: Jul. 12, 2024

(30) Foreign Application Priority Data
Nov. 24, 2023 (DE) 10 2023 132 802.6

(51) Int. Cl. H01H 85/165; B29C 57/10; B29C 61/06; B29K 105/02; B29L 31/34; H01H 69/00; H01H 85/00

(52) U.S. Cl. CPC H01H 85/165; B29C 57/10; B29C 61/0608; H01H 69/00; B29K 2105/02; B29L 2031/3412; H01H 2085/0008

(57) ABSTRACT

A shrink cap for receiving a temperature-dependent switch. The shrink cap includes an open first end for sliding onto the switch and a closed second end which is closed by a welded or embossed seam that extends from an end face arranged in an area of the second end and resulting from the welded or embossed seam. The welded or embossed seam is formed in such a way that a formed section of the welded or embossed seam bears against the end face directly or with an interposed joining agent.

### CROSS-REFERENCE TO RELATED APPLICATIONS

This application claims priority from German patent application DE 10 2023 132 802.6 filed on Nov. 24, 2023. The entire contents of this priority application are incorporated herein by reference.

### FIELD

This disclosure relates to a shrink cap and a method of manufacturing a shrink cap. This disclosure further relates to a device comprising a temperature-dependent switch and a shrink cap.

### BACKGROUND

An exemplary shrink cap and an exemplary method of manufacturing such a shrink cap are disclosed in EP 0 857 562 B1.

Such shrink caps are typically held in bulk and pushed onto electrical devices to be protected, such as temperature-dependent switches, and then shrunk by using hot air to create a sheathing that protects the device from dirt, moisture and electrical contact with other components. The connection elements of the device, which are often configured as stranded wires or cables, then protrude from this sheathing.

Such shrink caps are usually produced by first cutting heat-shrink tube sections to length from a heat-shrink tube and then creating a welded or embossed seam at one of its two ends. For this purpose, the heat-shrink tube section is pressed together at the end and the welded or embossed seam is created, for example, by means of two welding stamps that act on the end of the heat-shrink tube section from opposite sides by means of pressure and heat.

As the welded or embossed seam is created by pressing one end of the heat-shrink tube together and joining the longitudinal halves of the heat-shrink tube that are pressed together, the welded or embossed seam typically has approximately twice the wall thickness of the rest of the heat-shrink tube. This results in a comparatively stiff and rigid welded or embossed seam.

The welded or embossed seam protrudes from a closed end face, which is created by the welded or embossed seam on the heat-shrink tube or shrink cap, respectively. Due to the manufacturing process, there is usually a very sharp edge along the free, protruding end of the welded or embossed seam. This sharp edge remains when the shrink caps are shrunk onto the devices to be protected.

Many process steps are typically carried out by hand, both in the assembly of the devices with the shrink caps and in the further processing of the devices fitted with the shrink caps, wherein the persons performing these process steps have to perform very fine motorized work, so that they cannot wear protective gloves.

Due to the sharp edges of the welded or embossed seams, this type of manual work could cause injuries, which of course represents a major disadvantage.

In order to avoid this, people sometimes do not grip the sheathed components by the shrink cap itself, but by the connecting cables. However, this can lead to the connection between the connecting cable and the sheathed component being weakened or even completely destroyed during the further manipulations that are required, so that the apparatus made from such components can sometimes have defects.

In particular, if the devices are temperature-dependent switches, which, for example, protect a coil from overheating, the switches encased in the shrink caps are brought into direct contact with the coil, e.g. of electric motors. The switches are electrically connected in series to the coil and interrupt the electric circuit if the temperature of the coil exceeds a predetermined value. For this purpose, a bimetallic switching mechanism is arranged inside the temperature-dependent switch in a known way.

In order to reliably fulfill this protective function, it may be necessary to arrange the switch inside the coil or at least bring it very close to the coil. The sharp edge of the shrink cap can thereby also cause damage to the coil, which is of course disadvantageous as well.

According to EP 0 857 562 B1, the aforementioned problems are solved by treating the shrink cap again after the welded or embossed seam has been created. During this post-treatment, the welded or embossed seam is bent over with a forming punch. By this bending, the sharp-edged, free end of the welded or embossed seam is rolled up or folded in, so to speak, so that it no longer protrudes from the front of the shrink cap in a straight way.

This measure may prevent the above-mentioned problems of injury and the risk of damage to other devices.

Nevertheless, there is still potential for improvement in the manufacture of such shrink caps. For example, it has been shown that shrink caps whose welded or embossed seams are bent by 90° or more, as described in EP 0 857 562 B1, become mechanically unstable and can therefore break off more easily. This in turn can lead to open areas in the shrink cap, as a result of which the protective function of the shrink cap can be fundamentally lost. In addition, this can impair the voltage or high-voltage resistance of the shrink cap, which is an important property of the shrink cap, in particular when used on temperature-dependent switches.

### SUMMARY

It is an object to provide a shrink cap and a method of manufacturing such a shrink cap with which the above-mentioned problems can be eliminated or at least reduced. It is, in particular, an object to reduce the risk of damage or injury which can be caused by such shrink caps and at the same time to ensure a mechanically stable, tight and high-voltage-resistant shrink cap.

According to a first aspect, a shrink cap is presented which is configured to receive a temperature-dependent switch. The shrink cap comprises an open first end; and a second end which is closed by a welded or embossed seam; wherein the welded or embossed seam extends from a closed end face of the shrink cap; wherein the welded or embossed seam is formed in such a way that a formed section of the welded or embossed seam bears against the end face directly or indirectly with a joining agent interposed between the welded or embossed seam and the end face.

According to a second aspect, a device comprising a temperature-dependent switch and a shrink cap that receives the temperature-dependent switch is presented, wherein the shrink cap comprises an open first end; and a second end which is closed by a welded or embossed seam; wherein the welded or embossed seam extends from a closed end face of the shrink cap; wherein the welded or embossed seam is formed in such a way that a formed section of the welded or embossed seam bears against the end face directly or indirectly with a joining agent interposed between the welded or embossed seam and the end face.

According to a third aspect, a method of manufacturing a shrink cap is presented, comprising:
a) providing a heat-shrink tube section comprising a first opening at its first end and a second opening at its second end,
b) pressing the shrink tube section together at its second end and producing a welded or embossed seam to close the second opening and create a closed end face in the area of the second end,
characterized by the furthermore step:
c) forming a section of the welded or embossed seam such that the formed section of the welded or embossed seam bears against the end face directly or with an interposed joining agent.

In contrast to what is proposed in EP 0 857 562 B1, the welded or embossed seam is not only bent, folded or rolled in at 90° or more towards the end face of the shrink cap, but is formed in such a way that it is at least partially in contact with the end face. Preferably, the welded or embossed seam is folded over by approximately 90° and placed against the end face of the shrink cap in such a way that at least a section of the welded or embossed seam lies against the end face of the shrink cap directly or indirectly with an interposed joining agent.

This has several advantages: firstly, the shrink cap and thus also the device (e.g. the temperature-dependent switch) to which the shrink cap is applied is further shortened. This smaller size is advantageous both in terms of bulk storage of the shrink cap and in terms of handling and installation options for the shrink cap. Furthermore, it has been shown that by applying the welded or embossed seam to the end face of the shrink cap, the risk of injury and damage is further reduced, as the sharp-edged edge of the welded or embossed seam can be applied completely to the end face of the shrink cap, so that it no longer protrudes from the shrink cap at all and is therefore hardly accessible. Furthermore, it has been shown that this creates a kind of double or multiple wall at the end of the shrink cap, as the welded or embossed seam bearing against it additionally increases the wall thickness at the end of the shrink cap. This in turn creates further mechanical stability. Initial tests by the applicant have also shown that this can substantially improve the high-voltage resistance of the shrink cap. While conventional shrink caps show a high-voltage resistance in the area of 1.5-2.5 kV, a high-voltage resistance of 3.5 kV or more can be realized with the herein presented shrink cap.

In a refinement, the welded or embossed seam comprises a free end and an end portion adjoining the end face, wherein the formed section of the welded or embossed seam, which bears against the end face directly or with the interposed joining agent, extends over an area between the free end and the end portion adjoining the end face.

The welded or embossed seam is therefore preferably in contact with the end face of the shrink cap at least with a central section that extends between the free end and the end portion adjacent to the end face.

In a further refinement, it is preferred that more than 50% of an area of one side of the welded or embossed seam bearing against the end face bears against the end face directly or with the interposed joining agent.

In other words, it is preferred that a large part of the welded or embossed seam bears against the end face of the shrink cap. This further improves the mechanical stability and high-voltage resistance of the shrink cap.

It is particularly preferable for the welded or embossed seam to bear completely against the end face, directly or indirectly with the interposed joining agent.

The welded or embossed seam is preferably bent through 90° and placed with one side against the end face of the shrink cap. Preferably, the welded or embossed seam does not protrude beyond the outer edge or circumference of the shrink cap. This way, the greatest possible mechanical stability and high-voltage resistance is ensured. At the same time, the risk of injury and damage posed by the shrink cap is reduced to a minimum.

In a further refinement, the formed section of the welded or embossed seam is pressed against the end face.

This preferably results in a seamless, essentially wrinkle-free welded or embossed seam applied to the end face of the shrink cap. Preferably, the section or the entire welded or embossed seam is thermoformed or hot-formed by heating, whether by hot air from the outside and/or a hot forming die, and then pressed against the end face of the shrink cap. This results in a very compact shrink cap, which comprises a high level of stability and high-voltage resistance, in particular in the area of the end face.

In a further refinement, the formed section of the welded or embossed seam is fixed to the end face in a material-locking manner.

For example, the welded or embossed seam, after it has been produced and formed, is glued or welded to the end face of the shrink cap with the formed section. This ensures that the formed section of the welded or embossed seam remains permanently attached to the end face, as it is additionally fixed to it.

In a further refinement, the end face of the shrink cap is convexly curved. Particularly preferably, the end face is curved when viewed in a longitudinal section of the shrink cap.

This additionally minimizes the risk of injury and damage posed by the shrink cap. In addition, this shape is particularly suitable for receiving temperature-dependent switches, which are usually cylindrical or round.

In a further refinement, the formed section of the welded or embossed seam extends approximately parallel to the convexly curved end face.

The formed section of the welded or embossed seam thus nestles up against the front of the shrink cap like a second wall. This also further improves the compactness, mechanical stability, high-voltage resistance and rigidity of the shrink cap.

In a further refinement, the shrink cap in an area between the first and the second end is substantially mirror-symmetrical to a first plane of symmetry, wherein the welded or embossed seam at its end portion adjoining the end face is arranged offset to the first plane of symmetry.

In other words, the welded or embossed seam is not produced in the center of the plane of symmetry of the heat-shrink tube section from which the shrink cap is made, but is offset off-center with respect to this first plane of symmetry. This has the advantage that the welded or embossed seam can be relatively large and does still not protrude laterally beyond the edges of the shrink cap after it has been bent over and applied to the end face. Even if the welded or embossed seam is placed completely with one of its sides against the end face of the shrink cap, it still does not protrude laterally, i.e. in a direction transverse to the first plane of symmetry, beyond the end face. The free, usually sharp-edged end of the welded or embossed seam therefore does not protrude laterally from the end face of the shrink cap. Subsequent cutting or shortening of the welded or embossed seam can therefore be omitted.

All this can be enabled by arranging the welded or embossed seam off-center or offset, even if the welded or embossed seam has a relatively large surface area. A large-area design of the welded or embossed seam increases the tightness of the joint and facilitates handling when producing the welded or embossed seam.

Preferably, a joining surface of the welded or embossed seam in the end portion of the welded or embossed seam adjacent to the end face is offset parallel to the first plane of symmetry.

The “joining surface” here refers to the surface along which the two longitudinal halves of the heat-shrink tube, which are pressed together and joined when the welded or embossed seam is produced, are connected to each other. This joining surface or joining plane runs parallel to the first plane of symmetry after the welded or embossed seam has been produced. However, since a section of the welded or embossed seam is then formed and placed against the end face of the shrink cap, the aforementioned definition of the parallel offset arrangement of the joining surface “only” refers to the end portion of the welded or embossed seam adjacent to the end face or arranged on the end face.

In a further refinement, the end face has a height measured orthogonally to the first plane of symmetry, wherein the welded or embossed seam is arranged at its end portion adjacent to the end face offset parallel to the first plane of symmetry by at least 1/10 of the height, preferably at least ⅕ of the height.

This makes it possible for the welded or embossed seam in its state applied to the end face to have a height measured orthogonally to the first plane of symmetry, which is larger than half the height of the end face and does thereby still not protrude laterally beyond the end face.

As mentioned, the above-mentioned refinements and the refinements defined in the claims relate not only to the shrink cap itself, but also to a temperature-dependent switch having such a shrink cap. Likewise, these refinements also relate to the method of manufacturing the shrink cap. This results, in particular, in the following further refinements for the method of manufacturing:

In a further refinement, the section of the welded or embossed seam is formed in step c) such that more than 50% of an area of one side of the welded or embossed seam bearing against the end face bears against the end face directly or with the interposed joining agent.

In a further refinement, the section of the welded or embossed seam is formed in step c) such that the welded or embossed seam bears completely against the end face, either directly or with the interposed joining agent.

In a further refinement, the section of the welded or embossed seam is pressed against the end face in step c) or after step c). Before or during this pressing process, the welded or embossed seam is preferably heated so that it can be formed more easily.

In a further refinement, the section of the welded or embossed seam is fixed to the end face in a material-locking manner in step c) or after step c).

In a further refinement, the section of the welded or embossed seam is formed in step c) such that the formed section extends approximately parallel to the end face.

In a further refinement, the welded or embossed seam is produced parallel offset to a first plane of symmetry of the shrink tube section in step b).

In a further refinement, the welded or embossed seam is produced in step b) offset from the first plane of symmetry of the shrink tube section such that the welded or embossed seam produced in step b) is essentially mirror-symmetrical with respect to a second plane of symmetry which is offset parallel to the first plane of symmetry.

In a further refinement, the welded or embossed seam is produced in step b) offset from the first plane of symmetry of the shrink tube section such that the welded or embossed seam produced in step b) is substantially mirror-symmetrical with respect to a second plane of symmetry which is offset from the first plane of symmetry by at least 1/10 of a height measured orthogonally to the first plane of symmetry, preferably at least ⅕ of the height.

In a further refinement, the welded or embossed seam is formed in step c) such that a free end of the welded or embossed seam does not protrude beyond the end face in a direction orthogonal to the first plane of symmetry.

It is understood that the features mentioned above and those to be explained below can be used not only in the combination indicated in each case, but also in other combinations or on their own, without departing from the spirit and the scope of the present disclosure.

### BRIEF DESCRIPTION OF THE DRAWINGS

FIG. 1 shows a schematic illustration of a shrink cap of the prior art in several views;

FIG. 2A shows a side view of a shrink cap according to a first embodiment;

FIG. 2B shows a sectional view of the shrink cap shown in FIG. 2A;

FIG. 3A shows a side view of a shrink cap according to a second embodiment;

FIG. 3B shows a sectional view of the shrink cap shown in FIG. 3A;

FIG. 4 shows a side view and a top view from the front of a shrink cap according to a third embodiment, wherein the shrink cap is shown here in an intermediate state occurring during production;

FIG. 5A shows a side view of the shrink cap according to the third embodiment, wherein the shrink cap is shown here in its finished final state;

FIG. 5B shows a sectional view of the shrink cap shown in FIG. 5A; and

FIG. 6 shows several schematically indicated process steps for manufacturing the shrink cap.

### DESCRIPTION OF PREFERRED EMBODIMENTS

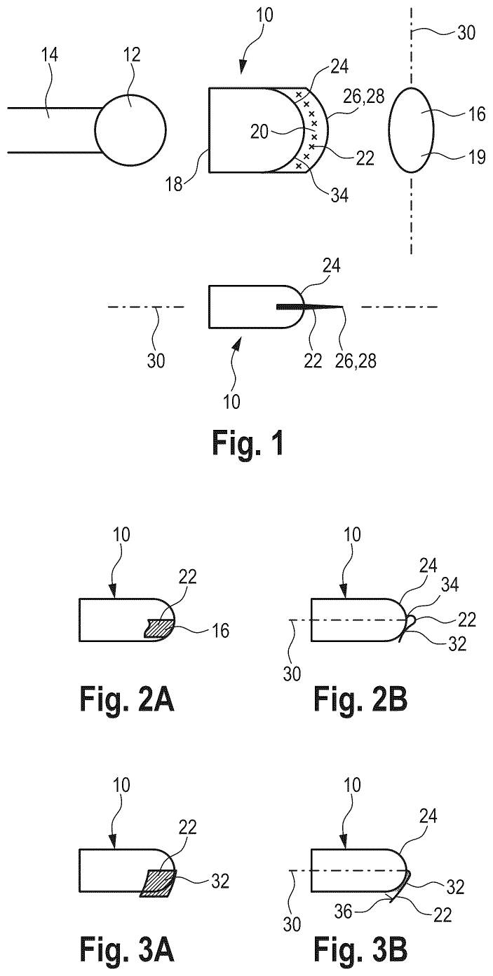

FIG. 1 shows a shrink cap according to the prior art in various schematic illustrations. The shrink cap is designated in its entirety with the reference numeral 10.

The shrink cap 10 shown in FIG. 1 may also be regarded as an intermediate state during the manufacture of the shrink cap 10. In other words, the shrink cap 10, which is explained in more detail in the following, is initially produced in the conventional way, but is further processed in a different way compared to the shrink cap previously known from the prior art.

The shrink cap 10 is used in particular for receiving a temperature-dependent switch 12, the external connections 14 of which are shown here in simplified form as stranded wires. Such temperature-dependent switches 12 are used to monitor electrical apparatus. In particular, they are used for this purpose to de-energize the electrical apparatus to be monitored in the event of overheating. Thereto, the switch 12 comprises a temperature-dependent switching mechanism, which is usually installed inside the switch housing and comprises a bimetallic part. This bimetallic part changes its shape upon exceeding a response temperature, whereby the switching mechanism is moved from its closed position to its open position. The electrical circuit in which the switch 12 is installed is then open. If the apparatus to be monitored then cools down again below a so-called reset temperature of the bimetal part, this in turn snaps back to its initial position, whereby the switch is brought back to its closed position. In this way, a temperature-dependent switching behavior of the switch 12 is realized.

The shrink cap 10 serves in particular to provide external protection and electrical shielding of the switch 12. The shrink cap 10 is put over the switch 12 and attached to it or shrunk onto it, so that the shrink cap 10 envelops the switch 12 on all sides in the final state.

However, it is understood that the shrink cap 10 is in principle also suitable for receiving other devices and is not limited to receiving a temperature-dependent switch, as shown in the present case.

The shrink cap 10, the cross-section of which is shown at 16, is slid onto the switch 12 with its first end 18 and then shrunk onto it using hot air, so that only the outer connections 14 protrude from the sheathing thus formed. The first end 18 is therefore configured as an open end comprising a first opening 19.

The second end 20 of the shrink cap 10 opposite the first end 18 is closed. Here, the shrink cap 10 comprises a welded or embossed seam 22 provided in the area of the second end 20. By this welded or embossed seam 22, the shrink cap 10 is completely closed in the area of its second end 20. Due to the welded or embossed seam 22, the shrink cap 10 comprises a closed end face 24 in the area of its second end 20, which is adjacent to the welded or embossed seam 22.

Due to the manufacturing process, the welded or embossed seam 22 is configured as a fold or edge that protrudes straight from the end face 24 of the shrink cap 10. This fold or edge is comparatively rigid or inflexible and comprises a relatively sharp edge 28 at its front, free end 26.

The face-side, free, front edge 28 of the welded or embossed seam 22 is curved in the shape of an arc when viewed from above (see the upper middle part of FIG. 1). This is also due to the manufacturing process, since the shrink cap 10, as explained in detail in the following, is produced in the area of its second end 20 by pressing together and then welding or embossing an initially still open end portion (an opening 21) of a cylindrical shrink tube to produce the welded or embossed seam 22.

At 16, the shrink cap 10 is illustrated as oval or elliptical in cross-section. However, the shrink cap 10 can also be approximately round when viewed in cross-section. The starting material used for the shrink cap 10 in the form of a heat-shrink tube is typically round or circular in cross-section, i.e. circular-cylindrical overall.

The end face 24 of the shrink cap 10 resulting from the welded or embossed seam 22 is configured to be convex, as can be seen in particular from the top view from above in the central upper part of FIG. 1 and from the side view in the lower part of FIG. 1. It is understood that the shape of the end face 24 shown here is illustrated schematically. In practice, this end face 24 is usually convexly curved, but typically not exactly as round and regular as shown in the present figures. However, due to the manufacturing process, as mentioned, such an arcuate rounding or curvature of the end face 24 results. Depending on the shape of the switch 12 onto which the shrink cap 10 is to be shrunk, the end face 24 can also be angular or approximately flat and the welded or embossed seam 22 may extend along a straight line. However, a round or curved welded or embossed seam 22 is advantageous for receiving a mostly round switch 12.

FIG. 1 shows the state of the shrink cap 10 after the welded or embossed seam 22 has been produced. This state corresponds to the final state of the vast majority of shrink caps used in the prior art to encase temperature-dependent switches. In this state, the shrink cap 10 is essentially mirror-symmetrical with respect to a first plane of symmetry, which is indicated in FIG. 1 with the reference numeral 30. The word “essentially mirror-symmetrical” is used in the present case to indicate that in practice there is typically no absolutely exact mirror symmetry. In principle, however, this mirror symmetry does exist and the minor deviations that occur in practice due to the manufacturing process, which are typically in the millimeter or tenths of a millimeter range, can be neglected.

The shrink caps 10 used in the prior art, if they are used in the state shown in FIG. 1 and are not further processed, can pose a comparatively high risk of injury to people and a risk of damage to parts of the machines in which the temperature-dependent switches 12 are installed together with their shrink caps 10 due to the relatively sharp edge 28 at the end face 26 of the welded or embossed seam 22.

The shrink cap 10 is further processed starting from the intermediate state shown in FIG. 1. Here, the welded or embossed seam 22 is formed such that at least a formed section 32 of the welded or embossed seam 22 is in contact with the end face 24 of the shrink cap 10. In other words, the welded or embossed seam 22 is bent over by approximately 90° or slightly more and is placed against the end face 24 at least in sections. The formed section 32 of the welded or embossed seam 22, which is placed against the end face 24 of the shrink cap 10, lies against the end face 24 either directly or indirectly with an interposed joining agent.

In FIGS. 2A, 2B, 3A and 3B, two different embodiments of the shrink cap 10 are shown in their finished final state. FIGS. 2A and 3A each show the shrink caps 10 in a side view. FIGS. 2B and 3B each show the shrink caps 10 in a longitudinal sectional view. The sectional plane is in each case perpendicular to the first plane of symmetry 30 indicated by a dashed line in FIG. 1.

As can be seen from FIGS. 2A-3B, the shrink cap 10 in its final state is now no longer mirror symmetrical to the first plane of symmetry 30 as a whole. However, the left-hand part of the shrink cap 10 is still essentially mirror symmetrical to the first plane of symmetry 30. In other words, apart from the welded or embossed seam 22, the finished shrink cap 10 is essentially mirror symmetrical to the first plane of symmetry 30.

In the first embodiment shown in FIGS. 2A and 2B, the welded or embossed seam 22 is folded over and glued in sections to the end face 24 of the shrink cap 10. In the area of the end portion 34 of the welded or embossed seam 22 adjacent to the end face 24, a smaller bead can result by folding over the welded or embossed seam 22, which protrudes slightly forward from the end face 24. Overall, however, the effective length of the shrink cap 10 is significantly shortened by folding over and placing the welded or embossed seam 22 against the end face 24. In addition, the sharp edge 28 of the welded or embossed seam 22 no longer protrudes from the front of the shrink cap 10. The risk of injury and damage is therefore significantly reduced. Furthermore, in the area of the folded-over welded or embossed seam 22, the shrink cap 10 has an improved high-voltage resistance, since the welded or embossed seam 22 creates a further layer in this section 32, so to speak, by which the wall thickness and thus also the high-voltage resistance of the shrink cap is increased.

In the second embodiment shown in FIGS. 3A and 3B, the welded or embossed seam 22 is applied to the end face 24 of the shrink cap almost completely or at least with a larger section than according to the second embodiment (cf. FIGS. 2A and 2B). Preferably, the welded or embossed seam 22 is pressed against the end face 24. This preferably results in a seamless, essentially wrinkle-free welded or embossed seam 22 applied to the end face 24 of the shrink cap 10. The described type of forming of the welded or embossed seam 22 is preferably carried out under the effect of heat, as explained in detail in the following.

Depending on the intended use, it can be preferable for the section 32 of the welded or embossed seam 22 applied to the end face 24 to be applied loosely to the end face or to be connected to it by an additional welding or bonding process.

Particularly preferably, the formed section 32 of the welded or embossed seam 22 according to the second embodiment shown in FIGS. 3A and 3B lies at least for the most part (i.e. with more than 50% of the area) of the bottom side 36, which is folded over onto the end face 24, against the end face 24.

Since the welded or embossed seam 22, depending on its size, can protrude quite far from the end face 24 in the initial state shown in FIG. 1, the folding over and positioning of the welded or embossed seam 22 can cause it to protrude downwards or laterally from the shrink cap 10, as can be seen in particular from FIG. 3B. In order to completely avoid the risk of injury and/or damage, it is then advantageous to cut the welded or embossed seam 22 to length or cut it off in the area of its end face end 26. However, this can have the disadvantage of causing leaks which impair the complete closure of the shrink cap 10 in the area of the second end 20. For example, cracks or holes can occur in the welded or embossed seam 22, through which impurities can enter the interior of the shrink cap 10. It goes without saying that this is a fundamental disadvantage.

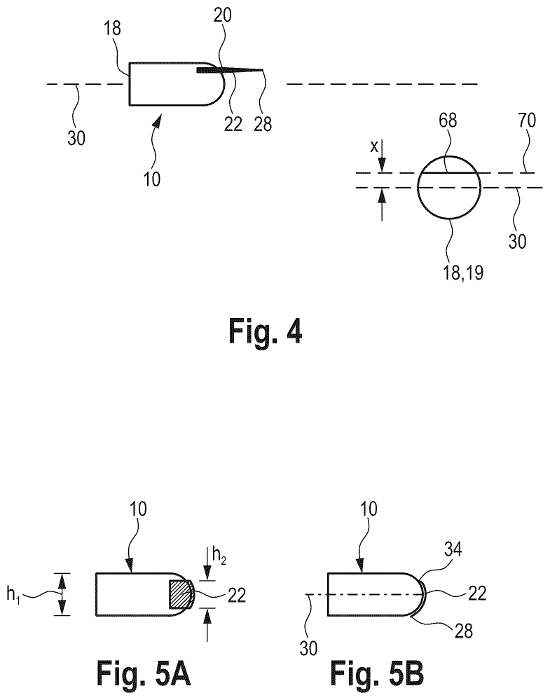

According to a third embodiment of the shrink cap 10, which is shown in FIGS. 4, 5A and 5B, the welded or embossed seam 22 can be arranged parallel offset to the first symmetry plane 30 described above. In other words, the welded or embossed seam 22 is not produced with the center of the shrink cap 10, but is offset in height relative to the plane of symmetry 30. FIG. 4 shows the intermediate state of the shrink cap 10 after the welded or embossed seam 22 has been produced (before the welded or embossed seam 22 has been formed). In this state, the shrink cap 10 according to the third embodiment is thus essentially mirror-symmetrical with respect to the first plane of symmetry 30 only in an area between the first end 18 and the second end 20. Due to the offset arrangement of the welded or embossed seam 22, the shrink cap 10 is not essentially mirror-symmetrical with respect to the first plane of symmetry 30 as a whole.

FIG. 4 on the right shows a top view of the shrink cap 10 from the front through the first opening 19. Here, the welded or embossed seam 22 can be seen as a line offset parallel to the first plane of symmetry 30. This line is formed by the joining surface 68, along which the two longitudinal halves of the heat-shrink tube, which are pressed together and joined when the welded or embossed seam 22 is produced, are joined. This joining surface 68 extends parallel to the first plane of symmetry 30 when producing the welded or embossed seam 22 according to the third embodiment shown schematically in FIG. 4. In other words, the joining surface 68 lies in a second plane of symmetry 70, to which the welded or embossed seam 22 is essentially mirror-symmetrical and which is parallel to the first plane of symmetry 30.

If, starting from the intermediate state shown in FIG. 4, the welded or embossed seam 22 is now formed and either only partially applied to the end face 24 in accordance with the first embodiment or applied in its entirety in accordance with the second embodiment, the sharp edge 28 of the welded or embossed seam 22 now no longer protrudes laterally or downwards from the shrink cap 10 (see FIGS. 5A and 5B). Further reworking, e.g. shortening of the welded or embossed seam, is no longer necessary. The risk of injury or damage is reduced to a minimum.

In the final state of the shrink cap 10 shown in FIGS. 5A and 5B, the welded or embossed seam 22 is indeed folded over in its entirety or approximately in its entirety. However, it is understood that the end or start section 34 of the welded or embossed seam 22 adjacent to the end face 24 is still offset parallel to the first plane of symmetry 30 described. Thus, this end or start section 34 means in particular the inner boundary line of the welded or embossed seam 22 at which it begins or at which the welded or embossed seam merges into the end face 24 of the shrink cap 10.

According to the third embodiment shown in FIGS. 4, 5A and 5B, the end portion 34 of the welded or embossed seam 22 adjacent to the end face 24 is preferably offset from the first plane of symmetry 30 by at least 1/10 of the height h1, further preferably by at least ⅕ of the height h1, particularly preferably by more than ⅓ of the height h1. The height h1 means the dimension of the shrink cap 10 measured orthogonally to the first plane of symmetry 30 in the area of the first end 18. The offset is indicated in the right part of FIG. 4 with reference sign x.

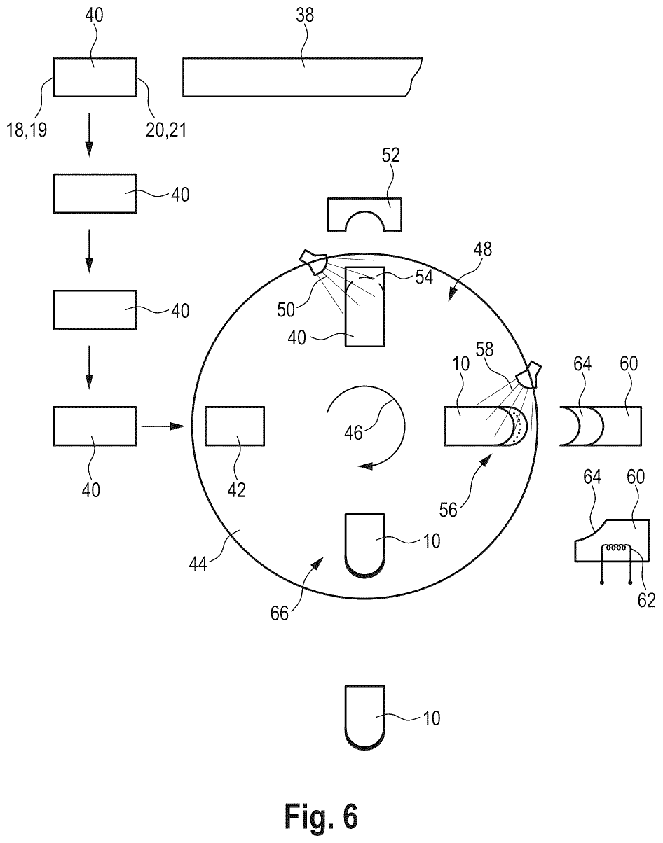

FIG. 6 schematically illustrates a method with which the shrink cap 10 can be produced from a heat-shrink tube 38.

First, short heat-shrink tube sections 40 with opposite open ends 18, 20, each comprising an opening 19, 21, are cut from the heat-shrink tube 38. These heat-shrink tube sections 40 are then slid one after the other onto a profile 42, which sits on a turntable 44.

After being pushed onto the profile 42, the turntable 44 is rotated by 90° in the direction of the arrow 46 indicated in FIG. 6 (here clockwise), so that the respective heat-shrink tube section 40 reaches a welding position 48.

At the welding position 48, the heat-shrink tube section 40 is heated and preformed by hot air indicated at 50, wherein two welding punches 52 simultaneously act on the second end 20 of the heat-shrink tube section 40. This closes the second opening 21 of the heat-shrink tube section 40 and produces the welded or embossed seam 22.

One of these two welding stamps 52 is schematically indicated in FIG. 6. At 54, it is also shown where the welding stamp 52 engages the heat-shrink tube section 40. Generally, the welding stamps 52 come from above and from below and thereby press the heat-shrink tube end together, wherein a welded or embossed seam 22, as shown in FIG. 1 or 4, is produced by the heating.

The shrink cap 10 now has the intermediate state shown in FIG. 1 or 4.

The turntable 44 is now rotated by a further 90° in the direction of the arrow 46, so that the shrink cap 10 reaches a forming position 56. Here, the welded or embossed seam 22 is preferably heated again by means of hot air 58 in order to make it easier to be formed. At the same time, a forming or pressing punch 60 is pressed against the welded or embossed seam 22 from the front in order to bend it and apply or press it against the end face 24 of the shrink cap 10.

The forming or pressing punch 60 is shown schematically in FIG. 6 on the right both in top view and in side view, wherein the side view comprises a heater 62 which can be used instead of the hot air 58 to heat the welded or embossed seam 22 with high accuracy before forming or during forming.

The forming or pressing punch 60 comprises a forming area 64 with an arcuate flank and is preferably adapted to the curvature of the end face 24 of the shrink cap 10.

As already mentioned, the welded or embossed seam 22 can additionally be connected to the end face 24 in this process step, i.e. it can be additionally welded or glued on. Alternatively, it is “only” applied or pressed to the end face 24.

Finally, the turntable 44 rotates again by 90° in the direction of the arrow 46, so that the finished shrink cap 10 reaches the ejection position 66 and is ejected, for example by means of compressed air. The shrink cap 10 produced in this way can then, for example, be stored as bulk material until it is used to encase a temperature-dependent switch.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A shrink cap that is configured to receive a temperature-dependent switch, comprising:
an open first end; and
a second end which is closed by a welded or embossed seam;
wherein the welded or embossed seam extends from an end face of the shrink cap;
wherein the welded or embossed seam is formed in such a way that a formed section of the welded or embossed seam bears against the end face directly or indirectly with a joining agent interposed between the welded or embossed seam and the end face.

2. The shrink cap as claimed in claim 1, wherein the welded or embossed seam comprises a free end and an end portion adjoining the end face, wherein the formed section of the welded or embossed seam extends over an area between the free end and the end portion.

3. The shrink cap as claimed in claim 1, wherein a first side of the formed section of the welded or embossed seam faces the end face, wherein more than 50% of a surface area of the first side of the formed section directly contacts the end face or the joining agent.

4. The shrink cap as claimed in claim 1, wherein a first side of the formed section of the welded or embossed seam faces the end face, wherein a complete surface area of the first side of the formed section of the welded or embossed seam directly contacts the end face or the joining agent.

5. The shrink cap as claimed in claim 1, wherein the formed section of the welded or embossed seam is pressed against the end face.

6. The shrink cap as claimed in claim 1, wherein the formed section of the welded or embossed seam is fixed to the end face.

7. The shrink cap as claimed in claim 1, wherein the formed section of the welded or embossed seam is glued or welded to the end face.

8. The shrink cap as claimed in claim 1, wherein the end face is convex.

9. The shrink cap as claimed in claim 8, wherein the formed section of the welded or embossed seam extends parallel to the convex end face.

10. The shrink cap as claimed in claim 1, wherein the shrink cap in an area between the first end and the second end is mirror-symmetrical to a first plane of symmetry.

11. The shrink cap as claimed in claim 10, wherein an end portion of the welded or embossed seam adjoining the end face is arranged parallel offset to the first plane of symmetry.

12. The shrink cap as claimed in claim 11, wherein a joining surface of the welded or embossed seam in the end portion is arranged parallel offset to the first plane of symmetry.

13. The shrink cap as claimed in claim 10, wherein the end face has a first height measured orthogonally to the first plane of symmetry, and wherein an end portion of the welded or embossed seam adjoining the end face is arranged offset parallel to the first plane of symmetry by at least 1/10 of the first height.

14. The shrink cap as claimed in claim 13, wherein the welded or embossed seam has a second height measured orthogonally to the first plane of symmetry, wherein the second height is measured from the end portion of the welded or embossed seam to a free end of the welded or embossed seam, and wherein the second height is larger than half the first height.

15. A device comprising a temperature-dependent switch and a shrink cap that receives the temperature-dependent switch, wherein the shrink cap comprises:
an open first end; and
a second end which is closed by a welded or embossed seam;
wherein the welded or embossed seam extends from an end face of the shrink cap;
wherein the welded or embossed seam is formed in such a way that a formed section of the welded or embossed seam bears against the end face directly or indirectly with a joining agent interposed between the welded or embossed seam and the end face.

16. A method of manufacturing a shrink cap, comprising the steps of:
providing a heat-shrink tube section comprising a first opening at a first end and a second opening at a second end;
pressing the heat-shrink tube section together at its second end and producing a welded or embossed seam to close the second opening and create a closed end face; and
forming of a section of the welded or embossed seam such that the formed section of the welded or embossed seam bears against the end face directly or indirectly with a joining agent interposed between the welded or embossed seam and the end face.
